(19) United States
(12) Patent Application Publication
(10) Pub. No.: US 2004/0054021 A1
(43) Pub. Date: Mar. 18, 2004

(54) Foamed material

(76) Inventor: Kenneth Malcolm Seargeant, Fleetwood, Lancanshire (GB)

Correspondence Address: ROTHWELL, FIGG, ERNST & MANBECK, P.C., 1425 K STREET, N.W., SUITE 800, WASHINGTON, DC, 20005, US

(21) Appl. No.: 10/466,088

(22) PCT Filed: Jan. 15, 2002
(86) PCT No.: PCT/GB02/00156

(30) Foreign Application Priority Data
Jan. 16, 2001 (GB) 010109802
Aug. 23, 2001 (GB) 0120477.5

(51) Int. Cl. C08J 9/26

(52) U.S. Cl. 521/61

(57) ABSTRACT

A method of making a foamed material comprises heating a mixture which includes a polymer, especially a polyaryletherketone polymer, and a decomposable material, especially magnesium hydroxide or aluminium hydroxide/hydrated alumina, to a foaming temperature at or above the decomposition temperature of the decomposable material. In the method, the decomposable material decomposes to produce water which produces foaming within the polymeric material.

This invention relates to foamed materials and provides a method of making a foamed material and a foamed material per se. Preferred embodiments relate to the preparation of a foamed material which comprises an engineering plastics material, for example a polyaryletherketone, especially polyetheretherketone.

Techniques for foaming polymers have been known for some time and are based on being able to cause a gaseous material to be released into a polymer which is then held in a state that will allow the expansion of the gas to increase the overall volume of the material. Many variations on the basic theme have been employed from dissolving gas in a supercritical state in the solid polymer followed by foaming on release of the pressure needed to cause sorption, to directly injecting gas into a melted polymer followed by cooling the foamed melt.

Attempts have been made to foam polyetheretherketone. For example, organic compounds have been proposed for use as blowing agents. However, to the applicant's knowledge, foamed polyetheretherketone materials are not commercially available.

It is an object of the present invention to address the problem of providing a foamed material which comprises a polymeric material.

According to a first aspect of the invention, there is provided a method of making a foamed material which comprises heating a mixture which includes:

(i) a polymeric material comprising a first polymer; and

(ii) a decomposable material comprising: a magnesium moiety and a hydroxide moiety; or an aluminium moiety and a hydroxide moiety;

to a foaming temperature at or above the decomposition temperature of the decomposable material.

In the method, suitably, the decomposable material decomposes to produce a gaseous product (e.g. water) which produces foaming within the polymeric material.

Preferably, the first polymer is softer at the foaming temperature than at ambient temperature. The first polymer is suitably soft enough at the foaming temperature to enable it to be foamed by a gaseous product produced from the decomposition of the decomposable material.

Preferably, the first polymer can be processed into a different shape (e.g. by extrusion) at the foaming temperature.

Preferably, during the processing of the first polymer, the polymer softens sufficiently to at least partially seal a processing device (e.g. an extruder) to prevent gas escaping without foaming the polymeric material.

Preferably, said first polymer is substantially stable during the method. Thus, the first polymer preferably does not substantially decompose during the method. Thus, if said heating is accomplished by a processing step, for example by extrusion as described hereinafter, said first polymer preferably does not substantially decompose during the processing—i.e. it is preferably stable long enough for the processing to be completed.

Preferably, the polymeric material can be processed into a different shape (e.g. by extrusion) at the foaming temperature.

Preferably, during the processing of the polymeric material, the material softens sufficiently to at least partially seal a processing device (e.g. an extruder) to prevent gas escaping without foaming the polymeric material.

Preferably, said polymeric material is substantially stable during the method. Thus, the polymeric material preferably does not substantially decompose during the method. Thus, if said heating is accomplished by a processing step, for example by extrusion as described hereinafter, said polymeric material preferably does not substantially decompose during the processing—i.e. it is preferably stable long enough for the processing to be completed.

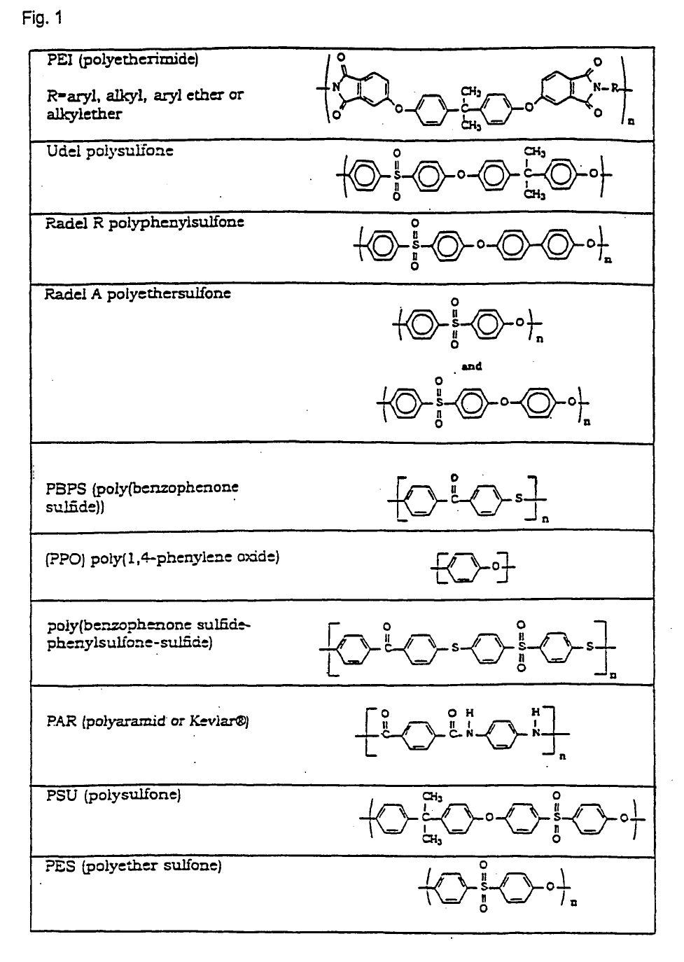

Said first polymer is preferably a high temperature engineering resin. Examples are provided in FIG. 1 of the accompanying drawings.

Said first polymer is preferably a polyether, especially an aromatic polyether, for example an aromatic polyetherketone or polyethersulphone. Preferred polyethers are those shown in FIG. 1.

Said first polymer is preferably a polyarylether ketone or sulphone. Said first polymer is preferably a polyaryletherketone, with polyetherketone and polyetheretherketone being especially preferred. Polyetheretherketone is the most preferred first polymer.

The melting temperature of the first polymer is preferably less than 400° C. to enable it to be foamed as described. The melting temperature may be greater than 330° C. Melting temperature may refer to the peak of the endotherm obtained by DSC.

Said polymeric material suitably includes at least 25 wt %, preferably at least 50 wt %, more preferably at least 60 wt %, especially at least 70 wt % of said first polymer. In some cases, said polymeric material may consist essentially of said first polymer.

Where said polymeric material does not consist essentially of said first polymer, said polymeric material may include a reinforcement means, adapted to improve the mechanical properties of the polymeric material in comparison to the first polymer alone. More particular, a said reinforcement means may be adapted to increase the tensile strength of the polymeric material over that of the first polymeric material alone. Said polymeric material preferably includes 40 wt % or less, more preferably 35 wt % or less, especially 30 wt % or less of reinforcement means. Said reinforcement means is preferably a fibrous material, for example comprising carbon and/or glass fibres. Alternatively, said reinforcement means could be plate-like.

Additionally and/or alternatively, where the polymeric material does not consist essentially of said first polymer, it may include a second polymer. A said second polymer may have any feature of said first polymer described herein and may, therefore, be one of the polymers shown in FIG. 1.

Examples of second polymers include polyethers and PTFE.

Furthermore, said polymeric material could include a third polymer which has any feature of the first and second polymers described but is not identical thereto.

Said polymeric material preferably includes 40 wt % or less, more preferably 35 wt % or less, especially 30 wt % or less of a said second polymer.

Said polymeric material preferably includes 20 wt % or less, more preferably 10 wt % or less, especially 5 wt % or less of a said third polymer.

Additionally and/or alternatively, where the polymeric material does not consist essentially of said first polymer, it may include a filler or fillers. An example of a suitable filler is carbon black. Said polymeric material preferably includes 20 wt % or less, more preferably 15 wt % or less, especially 10 wt % or less of filler.

Preferably, the sum of the wt % of reinforcement means, second polymer, third polymer and fillers in said polymeric material is 40 wt % or less, more preferably 35 wt % or less, especially 30 wt % or less.

In some cases, said mixture may include means (hereinafter a “reinforcing/crystallisation” means) for reinforcing cell walls of the foamed material during their formation and for inducing crystallisation within the softened and/or fluidic polymeric material. Such a means is preferably non-spherical and may comprise a material having its average smallest dimension (e.g. thickness) less than its average largest dimension, suitably by a factor of at least 2 (i.e. the average of the largest dimensions divided by the average of the smallest dimensions is at least 2), preferably by a factor of at least 3 or even at least 4. The average of the smallest dimensions may be less than 100 μm, preferably less than 50 μm, more preferably less than 10 μm, especially less than 5 μm. Said means may comprise plate-like particles. It may be a talc. Alternatively, it could be microfibrous or comprise nanotubes. An especially preferred reinforcing/crystallisation means is a talc.

Said mixture suitably includes less than 5 wt %, preferably less than 4 wt %, more preferably less than 3 wt %, especially less than 2.5 wt % of said reinforcing/crystallisation means.

Said decomposable material may comprise any compound which includes a magnesium moiety and a hydroxide moiety or an aluminium moiety and a hydroxide moiety which compound is decomposable in the method to produce a gaseous product (e.g. water). In one embodiment, said decomposable material comprises magnesium hydroxide. Substantially pure magnesium hydroxide could be used. Commercially available magnesium hydroxide may also be used and, in some cases, such material includes other additives. Preferably, said decomposable material comprises at least 80 wt %, more preferably at least 85 wt %, especially at least 90 wt % magnesium hydroxide. In another embodiment, said decomposable material comprises hydrated alumina or aluminium hydroxide, e.g. Al ₂O₃.3HOH or Al(OH)₃. Substantially pure hydrated alumina/aluminium hydroxide could be used or commercial grades which include other additives could be used. Preferably, the decomposable material comprises at least 80 wt %, more preferably at least 85 wt %, especially at least 90 wt % of hydrated alumina/aluminium hydroxide.

Preferably, said decomposable material used in said method comprises a magnesium moiety and a hydroxide moiety as described.

Said method is preferably carried out in the absence of any organic gas producing decomposable material. Preferably, no material, other than said decomposable material, decomposes when said mixture is heated in the method.

In the method, said polymeric material is suitably heated to a temperature at which the decomposable material decomposes. Preferably, the method involves heating the polymeric material to a temperature and/or for a time selected so that said first polymeric material does not substantially decompose in the method. Also, where said polymeric material includes a reinforcement means and/or a second polymer and/or a third polymer, the temperature and/or time are selected so that said reinforcement means and/or a said second polymer and/or said third polymer do not substantially decompose in the method. Where said polymeric material includes a filler or fillers (other than said decomposable material) said filler or fillers is/are preferably not substantially decomposed. Where a reinforcing/crystallisation means is provided said means is preferably not substantially decomposed in the method.

In the method, the temperature to which the polymeric material is heated preferably does not exceed 400° C.

Said mixture used in the method may include at least 60 wt %, suitably at least 70 wt %, preferably at least 75 wt %, more preferably at least 80 wt %, especially at least 85 wt % of said polymeric material.

Said mixture may include at least 0.5 wt %, suitably at least 1 wt %, preferably at least 2 wt %, more preferably at least 3 wt %, especially at least 4 wt % of said decomposable material. The amount of said decomposable material may be less than 20 wt %, suitably 15 wt % or less. Preferably, the amounts of decomposable material refer to the total amounts of all such materials which produce gaseous products in the method.

The particle size of said decomposable material is suitably selected so that it decomposes relatively rapidly. Thus, it should be relatively fine.

Said mixture is preferably substantially homogenous.

The mixture may be heated in the method to cause decomposition by any suitably means. Advantageously, however, the mixture is heated in a process in which an article of predetermined shape is formed from said polymeric material. For example, the mixture may be heated in an extrusion apparatus from which foamed material prepared in said method may be extruded, or the mixture may be heated in an injection moulding apparatus whereby foamed material is injected into a mould.

The method may be undertaken in an environment at ambient pressure. Alternatively, however, an external gas pressure could be used to control the foam.

It will be appreciated that the density of the foamed material produced in the method should be less than the density of the polymeric material used to prepare the mixture used in the method. The reduction in density will be dependent upon the amount of decomposable material that decomposes in the method and, in general, the more decomposable material used, the lower the density.

The mixture for use in the method may be prepared by mixing said polymeric material and the decomposable material, suitably in a separate step, before heating the mixture to said foaming temperature. Mixing may be undertaken at ambient temperature, for example by tumble blending or mixing may be achieved by compounding, especially melt compounding at an elevated temperature which is suitably less than the decomposition temperature of the decomposable material.

The polymeric material for use in preparing the mixture may be in the form of a powder or granules.

The foamed material produced in the method suitably incorporates a decomposition product of said decomposable material. Where said decomposable material includes magnesium hydroxide, the decomposition product is magnesium oxide and this is suitably retained in the foamed material and, therefore, acts as a filler therein. Where said decomposable material includes aluminium hydroxide/hydrated alumina, the decomposition product is aluminium oxide/alumina which may then act as a filler.

According to a second aspect of the invention, there is provided a foamable mixture which includes:

(i) a polymeric material comprising a first polymer; and

(ii) a decomposable material comprising a magnesium moiety and a hydroxide moiety or an aluminium moiety and a hydroxide moiety.

Whilst the polymeric material may have any feature of the material described herein, it is preferred that the first polymer is a polyether, more preferably a polyaryletherketone or polyarylethersulphone with polyetherketone and polyetheretherketone being especially preferred. The latter is most preferred.

A foamable mixture as described may be prepared by mixing the polymeric material and decomposable material. This may involve melt compounding the materials.

According to a third aspect of the invention, there is provided the use of a foamable material according to the second aspect for manufacturing a foamed material.

According to a fourth aspect of the present invention, there is provided a foamed material made in a method according to said first aspect.

A foamed material prepared as described herein may have many potential applications. In some applications, for example when used as a float or where porosity is important, the density of the foamed material is critical to the functioning of the foamed material. In other applications, a foamed material may be selected on cost grounds over the equivalent non-foamed material.

Preferably, said foamed material comprises an injection moulded or extruded product.

In one embodiment, said foamed material may be used to define a bio-compatible surface of a medical device or part thereof as described in PCT/GB01/02786. More particularly said foamed material may define a porous (foamed) layer on the outside of a support material. This structure may be prepared by extruding the foamed material onto the support material.

According to a fifth aspect of the invention, there is provided a foamed material comprising a polymeric material which includes a first polymer and magnesium oxide or aluminium oxide.

Said magnesium oxide or said aluminium oxide is preferably dispersed, preferably substantially homogeneously, throughout the polymeric material.

Said foamed material may include at least 0.3 wt %, suitably at least 0.7 wt %, preferably at least 1.3 wt %, more preferably at least 2 wt %, especially at least 3 wt % magnesium oxide or aluminium oxide. The weight of magnesium oxide or aluminium oxide may be 13.5 wt % or less, preferably 10 wt % or less.

The wt % of said polymeric material and/or each component thereof is/are preferably as described above according to said first, second and/or third aspects.

Any feature of any aspect of any invention or embodiment described herein may be combined with any feature of any aspect of any other invention or embodiment described herein.

Specific embodiments of the invention will now be described by way of example, with reference to FIG. 1 which shows various engineering plastics materials to which the invention described may be applied as described herein.

The following materials are referred to hereinafter:

Hydrofy GS 1.5 (Trade Mark)—a mineral containing >90% magnesium hydroxide obtained from Nuova Sima Srl of Genga, Italy. It contains Mg(OH)₂ (92.5%), MgCO₃ (2.5%), CaCO₃ (4.2%), FeO₃ (0.5%) and Mn₃O₄ (0.01%) and has an average particle size of 1.8 μm (by Sedigraph Micromeritics).

Hydrofy GS 2.5 (Trade Mark)—magnesium hydroxide as per Hydrofy 1.5 except the average particles size is 3.0 μm.

Analar Mg(OH)₂—obtained from Fisher Scientific, UK.

MagShield UF—magnesium hydroxide having an average particle size of 0.9 μm, obtained from Martin Marietta Magnesia Specialities of Baltimore, USA.

Apyral 120E—aluminium trihydroxide obtained from Nabaltec GmbH. The material comprises >99 wt % aluminium trihydroxide and has a median grain size diameter measured using laser granulometry of approximately 0.9 μm.

PEEK™150P (Trade Mark)—a low melt viscosity powdered polyetheretherketone obtained from Victrex Plc of Thornton Cleveleys, U.K. The material has a melting point (peak of endotherm obtained by DSC) of 343° C.

PEEK™450P (Trade Mark)—polyetheretherketone as per PEEK™150P except that 450P has a standard melt viscosity.

PEEK™150GL30 (Trade Mark)—a composite comprising polyetheretherketone (PEEK™150P described above) and 30% glass fibre reinforcement obtained from Victrex Plc of Thornton Cleveleys, U.K. The material has a melting point (peak of endotherm obtained by DSC) of 343° C., a density, measured according to ISOR1183, of 1.49 gcm⁻³ and a glass transition temperature of 143° C.

PES—polyethersulphone obtainable from BASF or Sumitomo.

### EXAMPLE 1

### General Procedures for Preparation of Blends

Where a blend included PEEK™450P, a relatively coarse grade, the materials used in the blend were tumble blended at ambient temperature.

Where a blend included PEEK™150P, a relatively fine grade, the materials used in the blend were melt compounded at 340° C. together with Hydrofy 2.5 (the least reactive mineral used) to form a blend.

In some situations, fine powders (e.g. PEEK™150P) may be incompatible with feed devices in injection moulding apparatus. In this case, materials used in a blend may be cold press compacted or granulated to produce a product which is readily compatible with injection moulding apparatus.

### EXAMPLE 2 TO 10

Blends of the type specified in Table 1 were prepared as described in Example 1 and each was extruded using a Plaston 1.5 inch extruder having a 18:1 L/d barrel and having a 5 mm die, at temperatures varying within the range 360° C. to 400° C.

| | | | Fraction by | |
|---|---|---|---|---|
| | Polyether- | | weight % of | Density of |
| | etherketone | Inorganic | inorganic | extrudate |
| Example No | grade used | Additive | additive | gcm⁻³ |
| 2 | 450P | Hydrofy 1.5 | 0.5 | 1.3 |
| 3 | 450P | Hydrofy 1.5 | 1 | 1.3 |
| 4 | 450P | Hydrofy 1.5 | 2 | 1.03 |
| 5 | 450P | Hydrofy 1.5 | 5 | 0.68 |
| 6 | 150P | Hydrofy 2.5 | 4 | 0.92 |
| 7 | 150P | Hydrofy 2.5 | 6 | 0.82 |
| 8 | 150P | Hydrofy 2.5 | 10 | 0.62 |
| 9 | 150P | Hydrofy 2.5 | 15 | 0.62 |
| 10 | 450P | Analar | 4 | 0.95 |
| | | Mg(OH)₂ | | |

The finer 1.5 μm Hydrofy material appeared to be the most efficient at density reduction at the temperature used. The analar magnesium hydroxide gave a density reduction similar to the 2.5 μm Hydrofy.

### EXAMPLE 11

The procedure of Examples 2 to 10 was used except that a 10 mm extrusion die was used. Details are provided in Table 2 .

| | | | Fraction by | |
|---|---|---|---|---|
| | Polyether- | | weight % of | Density of |
| | etherketone | Inorganic | inorganic | extrudate |
| Example No | grade used | Additive | additive | gcm⁻³ |
| 11 | 450 P | Hydrofy 2.5 | 10% | 0.5 |

It will be noted that using a larger die results in a reduction in density of the extrudate.

### EXAMPLE 12

The procedure of Examples 1 to 10 was followed for a blend comprising PEEK™450P and Hydrofy 2.5 (10 wt %). This was extruded through a 5 mm die, pulled through a water bath, cooled and then granulated so that it could be re-fed a second time through the die. Granulation and re-feeding as described was also carried out a third time.

The density after the first extrusion was 0.62 gcm⁻³; after the second time 0.73 gcm⁻³; and after the third time 0.74 gcm⁻³. This suggests that not all of the Hydrofy decomposes in the first extrusion or the second extrusion. Thus, it should be possible to achieve lower densities by using a longer extruder barrel and/or longer residence times.

### EXAMPLE 13

A blend comprising PEEK™450P (75 wt %) and PES (25 wt %) was prepared and then the blend was blended with Hydrofy 2.5 (10 wt %). The blend was extruded as described in Examples 2 to 10 to produce an extrudate having a density of 0.65 gcm⁻³.

### EXAMPLE 14

PEEK™150GL30 was blended with Hydrofy 2.5 (10 wt %) and extruded as described in Examples 2 to 10 to produce an extrudate having a density of 0.85 gcm⁻³.

### EXAMPLES 15 TO 21

An Arburg injection moulding machine fitted (for Examples 15 to 17) with a 4 mm * 50 mm * 50 mm plaque tool with 1 mm gate and fitted (for Examples 18 and 19) with a cup mould was used to injection mould blends described in Table 3. The density of plaques/cups produced is also detailed in the table.

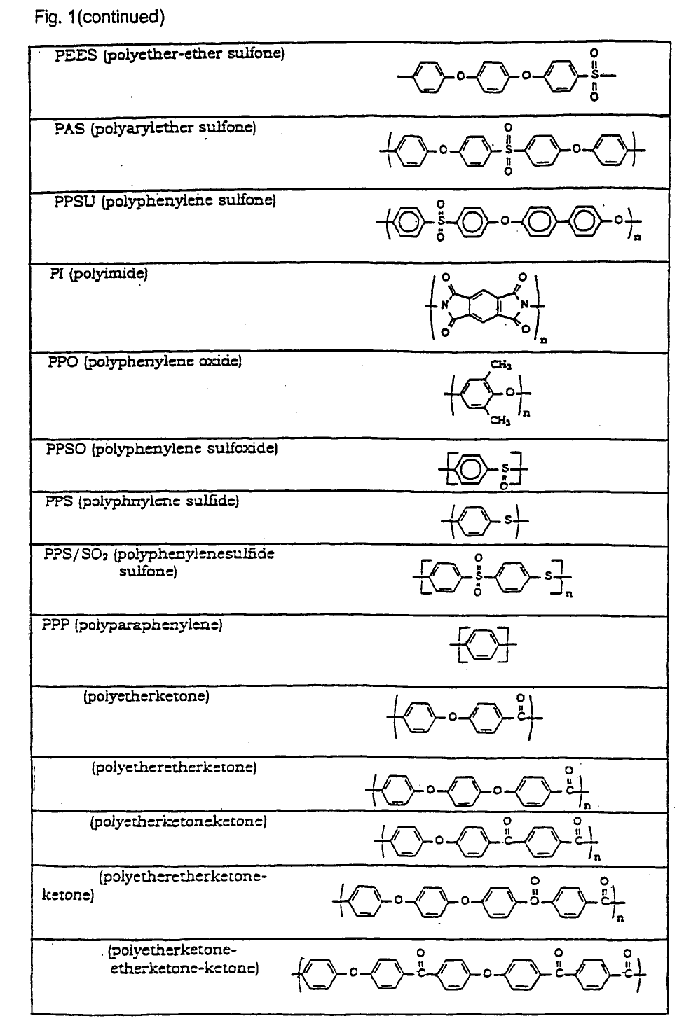

TABLE 1

| | | Density of plaque |
|---|---|---|
| | Composition/ | produced by |
| | Preparation of material | injection |
| Example No | for extruder | moulding (gcm⁻³) |
| 15 | PEEK ™ 150P and Hydrofy 2.5 (10 | 1.03 |
| | wt %) were compounded at 340° C. and | |
| | then extruded. The extrudate was granu- | |
| | lated and fed to the moulding machine | |
| | fitted with a plaque tool. | |
| 16 | PEEK ™ 450P and Hydrofy 2.5 (10 | 1.00 |
| | wt %) were tumble mixed at ambient | |
| | temperature and then extruded, the | |
| | extrudate granulated; and then in- | |
| | jection moulded as in FIG. 15. | |
| 17 | PEEK ™ 150P and Hydrofy 2.5 (10 | 0.8 |
| | wt %) were compaction granulated | |
| | (to enable practical feeding of | |
| | the relatively small injection | |
| | moulding machine); and then were | |
| | injection moulded as in Example 15. | |
| 18 | PEEK ™ 150P and Hydrofy 2.5 (10 | 0.5 |
| | wt %) were processed as described | |
| | in Example 15 and injection mould- | |
| | ed using a cup mould. | |
| 19 | PEEK ™ 450P and Hydrofy 2.5 (10 | 0.56 |
| | wt %) were processed as described in | |
| | Example 18. | |
| 20 | PEEK ™ 450P and Hydrofy 1.5 (10 | 0.5 |
| | wt %) were processed and moulded as | |
| | descibed in Example 18. | |
| 21 | PEEK ™ 150P and Hydrofy 1.5 (10 | 0.46 |
| | wt %) were processed and moulded | |
| | as described in Example 18. | |

It is noted that, in the thin section plaque mould, the PEEK™150-grade material foamed to a lower density than the PEEK™450 material. The lowest density (0.8 g/cc) was achieved with the material that had not previously been subjected to a high temperature compounding process.

Again with the larger section cup mould, the PEEK™150 material was seen to give a greater density reduction but the effect over the PEEK™450 was less pronounced than in the thinner plaque mould.

The thicker section cup mould gave a significantly reduced foam density in both examples when compared to the thin plaque mould showing a greater density reduction with increasing section thickness from this method of foaming.

### EXAMPLE 22

A block mould of dimensions 16 mm * 32 mm * 64 mm with an injection point on the face of the smallest area was used to prepare material from PEEKR™450P and Hydrofy 1.5 (10 wt %). The density of the material prepared was 0.47 gcm³.

### EXAMPLES 23 TO 25

The block mould of Example 22 was used to prepare material as described in Table 2.

TABLE 2

| | | Density of product |
|---|---|---|
| Example No. | COmposition: | (gcm⁻³) |
| 23 | PEEK ™ 150P and | 0.47 |
| | Hydrofy 1.5 (10 wt %) | |
| 24 | PEEK ™ 450 and | 0.34 |
| | MagShield UF (10 wt %) | |
| 25 | PEEK ™ 450P and | 0.37 |
| | MagShield UF (5 wt %) | |

The MagShield UF was the finest material used in the aforementioned examples and it gave the lowest density product.

### EXAMPLE 26

The cell structure of the products of Examples 24 and 25 were found to be very irregular. To strengthen the cell walls and encourage a more rapid crystallisation of what would otherwise be a slow cooling part with poor thermal conductivity due to its relatively thick section, talc was added. Thus material was prepared as described in Example 22 using PEEK™450P, MagShield UF (5 wt %) and talc (2 wt %) having nominal platelet diameter of about 5 μm. The product had a density of 0.36 gcm⁻³ and had an even cell structure. The tendency of walls to suck in was less noticeable with the shape of the product as seen by the eye being reproduced accurately.

### EXAMPLES 27 AND 28

The apparatus as described for examples 2 to 10 was used to extrude a blend comprising PEEK™450P and Apyral 120E (aluminium trihydroxide) (5 wt % for example 27 and 10 wt % for example 28). The respective extrudates had a density of 0.7 gcm⁻³ (Example 27) and of 0.64 gcm⁻³ (Example 28).

### EXAMPLE 29

A preblended compound consisting of 5% by weight magnesium hydroxide (Hydrofy 1.5) and PEEK™450P supplied by Victrex plc was fed into a 1.5 inch Plaston single screw extruder and heated up in stages to approx 400° C. The extrudate was expelled through an adjustable slit die as a foam on to a strip of PEEK™ film cut to fit onto a laboratory sized band caster. As the bandcaster rotated the extruded material formed a drawn foamed layer on the surface of the PEEK™ film.

A section of this foamed composite strip was removed, mounted on a solid plaque and the foamed surface subjected to mechanical abrasion so as to revolve the surface layer. The exposed surface structure was seen under an optical microscope as comprising a complex microstructure of pores. The pores were predominantly in the size range 50 to 200 microns.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiments(s). The invention extend to any novel one, or any novel combination, of the features disclosed in this specification (including any accompanying claims, abstract and drawings), or to any novel one, or any novel combination, of the steps of any method or process so disclosed.

1. A method of making a foamed material which comprises heating a mixture which includes:
i) a polymeric material comprising a first polymer; and
ii) a decomposable material comprising: a magnesium moiety and a hydroxide moiety; or an aluminium moiety and a hydroxide moiety;
to a foaming temperature at or above the decomposition temperature of the decomposable material.

2. A method according to claim 1, wherein the decomposable material decomposes to produce a gaseous product which produces foaming within the polymeric material, wherein said gaseous product comprises water.

3. A method according to claim 1 or claim 2, wherein said first polymer is a polyether.

4. A method according to any preceding claim, wherein said first polymer is a polyaryletherketone.

5. A method according to any preceding claim, wherein said first polymer is polyetheretherketone.

6. A method according to any preceding claim, wherein the melting temperature of the first polymer is less than 400° C. and is greater than 330° C.

7. A method according to any preceding claim, wherein said mixture includes means for reinforcing cell walls of the foamed material during their formation and for inducing crystallisation within the softened and/or fluidic polymeric material, wherein said means comprises a talc.

8. A method according to any preceding claim, wherein said decomposable material comprises magnesium hydroxide, hydrated alumina or aluminium hydroxide.

9. A method according to any of claims 1 to 7, wherein said decomposable material comprises a magnesium moiety and a hydroxide moiety.

10. A method according to any of claims 1 to 7, wherein said decomposable material comprises an aluminium moiety and a hydroxide moiety.

11. A method according to any preceding claim, wherein the temperature to which the polymeric material is heated does not exceed 400° C.

12. A method according to any preceding claim, wherein said mixture used in the method includes at least 60 wt % of said polymeric material and includes at least 0.5 wt % and less than 20 wt % of said decomposable material.

13. A method according to any preceding claim, wherein the mixture is heated in a process in which an article of predetermined shape is formed from said polymeric material.

14. A foamable material which includes:
i) a polymeric material comprising a first polymer; and
ii) a decomposable material comprising a magnesium moiety and a hydroxide moiety or an aluminium moiety and a hydroxide moiety.

15. A foamable material according to claim 14, wherein said first polymer is selected from polyetherketone and polyetheretherketone.

16. The use of a foamable material according to claim 14 or claim 15 for manufacturing a foamed material.

17. A foamed material made in a method according to any of claims 1 to 13.

18. A foamed material comprising a polymeric material which includes a first polymer and magnesium oxide or aluminium oxide.

19. A foamed material according to claim 18, wherein said first polymer is selected from polyetherketone and polyetheretherketone.
